(19) United States
(12) Patent Application Publication
(10) Pub. No.: US 2001/0032100 A1
(43) Pub. Date: Oct. 18, 2001

(54) Dynamic remotely accessible medical record

(76) Inventors: Khalid Mahmud, Eden Prairie, MN (US); C. Richard Abbruscato, Eden Prairie, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 09/745,847

(22) Filed: Dec. 22, 2000

Related U.S. Application Data
(60) Provisional application No. 60/171,965, filed on Dec. 23, 1999.

(51) Int. Cl. G06F 17/60

(52) U.S. Cl. 705/2

(57) ABSTRACT

The present invention is a dynamic remotely accessible medical record system comprising a multi-level access medical information database containing medical information networked with one or more remote terminals, and optionally with one or more input devices. The database provides for a user authorization protocol to protect the confidentiality of the records contained therein. The user authorization protocol provides a base access level and a high access level. The base access level allows the authorized user to view a particular patients information. A base access level user may not directly update the database. A high access level user may both view and update a patient's medical information. A user may be either a person at a networked terminal, a telemedicine apparatus, or an electronic medical measurement instrument.

### CLAIM TO PRIORITY

The present application claims priority to United States provisional patent application No. 60/171,965, filed Dec. 23, 1999 and entitled “A Dynamic Remotely Accessible Medical Record.” The identified provisional application is hereby incorporated by reference.

### FIELD OF THE INVENTION

The present invention relates to medical record keeping and, more particularly to, a medical record system that is dynamically updateable using telemedicine equipment and by various health care professionals via the internet to a central medical records website.

### BACKGROUND OF THE INVENTION

Medical records exist primarily for the use of health care providers to record the information related to the continuing care of each patient. These records are generally created by physicians after various episodic encounters with a patient. As such, the medical record is only episodically updated and does not provide a continuously updated status of the patient's well-being and medical care.

Certain types of medical record systems on the internet allow a patient to type-in their medical history themselves. However, because the medical information is not provided by a medical professional or by a telemedicine device controlled by a medical professional, the patient-entered data can often be inaccurate and, thus, unreliable.

The ideal medical record should be complete and current, providing continuously updated, reliable medical information rather than just episodically updated medical information about a patient. Further, the ideal medical record should be easily accessible to the patient and healthcare provider, readily readable, and easily updated. Additionally, the ideal medical record is preferably established by medical professionals and/or medical professional controlled/monitored equipment, e.g. telemedicine equipment. While being readily accessible to authorized personnel at any location, it must be private and secure from access by unauthorized persons. While being easily updateable it must be, at least in part, unalterable. In addition, it must provide means to identify, with certainty, the author of each entry.

The information in medical records is the property of the patient. The physical record and the means of storing it remain the property of the health care entity that maintains it. This distinction usually requires that releases be obtained from the patient to allow access to persons other than those that have created the record. This can be cumbersome.

Paper medical records have been used for many years and remain the standard way of doing things even now. They have many limitations, however. Paper records often suffer from a lack of legibility and inconsistency of format. Notes are often handwritten. Paper, while durable, suffers from wear. The paper record can only be in use at one location at a time and is often unavailable to one practitioner while another is making his entries. Paper records require large secured storage spaces and strong shelves or cabinets to support their weight. A staff of trained personnel must be maintained to file, retrieve and keep track of the records. Loss, damage or destruction of the records can occur due to numerous mishaps such as flood, fire or even a spilled beverage. Backup of paper records is very difficult, time consuming and expensive. A patient's medical record is, in fact, a multitude of records that are scattered amongst many providers, hospitals, clinics and schools.

In an effort to reduce inconsistency of format the Problem Oriented Medical Record (POMR) was introduced in the 1960s by L. L. Weed. This system relies on the acronym SOAP as a standard approach to recording entries. The four parts of this acronym are expressed as follows:

Subjective-this summarizes the patient's statement of his or her concerns, history and the story of what has transpired. It includes the chief complaint or concern.

Objective-the practitioner's observations, and results of physical evaluation.

Assessment-the practitioner's opinion of diagnosis based on the subjective and objective findings.

Plan-what the practitioner intends to do next and instructions to the patient as to treatment and further evaluation or testing.

In addition, there are areas in the record for laboratory test results, x-ray reports, other medical imaging studies and correspondence from consultants.

Current medical records are updated only when an entry is made by a health care provider and thus may be considered to be static between those entries. A truly current medical record requires a continuing input of information. Frequent monitoring of patient's using telemedicine equipment, e.g. interactive video, audio, and medical devices, can provide such continuous information, thus creating a “dynamic medical record.” Further, information can directly be entered from the patient via automatic data gathering instrumentation, in the same telemedicine equipment.

The ability to do in depth epidemiological studies requires the option to access a large number of records to withdraw and collate disease data. It is difficult to access large numbers of paper medical records that may be required to carry out epidemiological studies. The fact that the records are largely hand written or typed makes this type of data access a laborious non-automatable task

All of these issues have lead to various attempts to computerize patient medical record keeping. Even Weed, the originator of the POMR, was an advocate for the use of computer power to improve the process and the product. Computerized systems allow legibility, improved access, relative ease of backup, and compact storage of large amounts of information.

These computerization efforts have often involved large hospitals, clinics or teaching institutions and have used a variety of data storage protocols. These systems are often in house and proprietary and thus difficult to access from outside the entity that owns them.

For example, if a patient appears at the emergency room with an acute problem he is seen by a physician who has no knowledge of patient's past medical history. Hospitalization records may be available but, these often are not up to date on current conditions, diagnoses or medications This requires the physician to either invest a great deal of time gathering historical data, or worse, make decisions with incomplete information. This also encourages the use of excess laboratory and imaging testing that may not be necessary. If the ER physician could access the patient's current record quickly via the now ubiquitous Internet/World Wide Web the decisions made can be quicker and are more likely to be accurate and potentially could be life saving.

Thus, there is a need for a medical records system wherein a patient's medical record provides a continuous up-to-date record of a patient's clinical status that is accessible at all times to authorized physicians and other authorized interested parties.

### SUMMARY OF THE INVENTION

The present invention is a dynamic remotely accessible medical record system comprising a multi-level access medical information database containing medical information networked with one or more remote terminals, and optionally with one or more input devices. The database provides for a user authorization protocol to protect the confidentiality of the records contained therein. The user authorization protocol provides a base access level and a high access level. The base access level allows the authorized user to view a particular patients information. A base access level user may not directly update the database. A high access level user may both view and update a patient's medical information. A user may be either a person at a networked terminal, a telemedicine apparatus, or an electronic medical measurement instrument.

### BRIEF DESCRIPTION OF THE DRAWING

FIG. 1 is a flow diagram showing the data flow associated with the dynamic remotely accessible medical record.

### DETAILED DESCRIPTION OF THE INVENTION

The instant invention comprises a system for creating and maintaining a dynamic remotely accessible medical record (DRAMR), that is updated continuously via the internet to a central medical records website. The updates may be performed by a central patient monitoring service, by various health care providers and by automated input from automatic recording medical instruments. The data is electronically stored in a standardized format that can be accessed in a variety of ways.

The initial construction of the DRAMR comprises the accumulation of data from existing medical records from a variety of sources such as physicians, hospitals and other health care providers as well as patient history information from the patient. This data is stored digitally in a standardized format preferably based on the SOAP approach, however, other data formats may be used without departing from the spirit or scope of the invention. Additionally patient-monitoring data accumulated via a home telemedicine system may be included. The DRAMR that is created is preferably stored on the central medical records website.

Home telemedicine monitoring or telehomecare comprises providing the homebound or remotely located patient with a monitoring unit that is placed in the patient's home and connected to a home care nurse or other health care provider via the patients existing telephone line or internet connection. The unit generally allows verbal and video interaction between the patient and the nurse as well as the ability to monitor various medical data such as heart sounds, blood pressure, blood glucose, pulse oximetry, spirometry and potentially many other data. Automated measuring instruments may be used by the patient to gather information that is uploaded to the central station and/or central medical records website for entry into the patient's DRAMR.

Additionally, patients may be provided direct internet access to the DRAMR to enter their feelings about their well being as diary entries. These entries are preferably stored separately from health professional entries. Such diary entries may be limited to multiple choice, yes and no answers, or, may allow the patient the ability to provide expanded entries.

That which makes this form of medical record keeping dynamic is the regular updating of medical information. This updating preferably occurs weekly during the telehomecare visits by healthcare professionals. These interactions preferably include the notes of the health care professional as well as any instrumented test results acquired. However, other time periods may be established without departing from the spirit or scope of the invention, e.g. the information gathered by the patient's telemedicine equipment may be used to update daily, hourly, etc. The time period may be adjusted as required by direction from the health care professional.

Instrumentation that may be used to gather information preferably includes one or more of the following: telephonic stethoscopes, EKGs or rhythm strips, pulse oxymeters, weight, scales, thermometers, spirometers, peak flow meters, blood glucose meters, prothrombine time and other blood tests, and compliance devices. Of course, other medical data gathering devices may be used without departing from the spirit or scope of the invention. The type of information gathered is not limited strictly to data but may also include audio, video, audio/video clips or digital snapshots.

Other healthcare providers may be provided access to the DRAMR in order to enter information. Patient office visits may be one source of this data. The physician or other health care provider preferably accesses the patient's record via the internet and central medical records website to enter this information. Such information is preferably held separate from the permanent record until verification can occur.

Emergency visits may be utilized as another source of information. Further, hospitalization records may also be included in the DRAMR as well as information from other health related activities. Dental, eye care, physical or occupational therapy and others may also be accommodated, if desired. Again, all of the patient's medical information is preferably entered into the patient's DRAMR via an internet connection to the central medical records website.

The receipt of information from outside sources is preferably verified before it is entered into record at the central medical record website, i.e. that the source providing information is verified as a valid source. This is preferably performed by a digital signature protocol as well as by tracking the source of the information. However, other means of verification may be used without departing from the spirit or scope of the invention. Review of information from outside sources prior to permanent entry into the DRAMR may be required, which may require human intervention. Further, an encryption scheme is preferably used for patient information going over the internet, either for insertion into the DRAMR, or for patient information that is accessed and/or viewed from the DRAMR

The user authorization protocol preferably provides for hierarchical access authority. This means that there are basic users that have “read only” access and superusers that have both read and write access. The purpose of having hierarchical access authority is to ensure that the information included in the database is as accurate as possible. Persons such as the patient's doctor or hospital are likely to enter data that is correct for the patient. There is also a diagnostic motivation to have real time udpdatability of the record database. However, allowing persons such as the patient themselves, their family or non-regular doctors to enter information is potentially troublesome and may lead to life threatening complications in a works case scenario. Therefore, patients and other users authorized to view a patient's information have a base level of access. The patient's doctor, clinic, hospital, or others as designated, may be provided update capability as a superuser. Additionally, patients and other users as designated may access the patient diary portion of the database for viewing information therein. The patients would be provided authority to enter and/or edit diary information.

In the preferred embodiment, the user authorization protocol is presented to the user as a typical login screen comprising three datafields. The first datafield is a patient ID code. This is important to keep certain users who may otherwise have access from accessing all patients' information. The second datafield is a user ID code. The user ID code would be checked against the authority tables contained in the central database for determination of validity and authority level.

Optionally, the above may be modified to comprise three datafields. The first and second are the same as described herein, and the third field is a unique password. This configuration adds an additional layer of security.

If the user in the particular instance is a medical data acquisition device as described herein, it would have a unique user code included in its interface. This would permit the medical data acquisition device superuser writeability.

Confidentiality of the record is assured preferably by limiting access to the DRAMR to those persons authorized by the patient or, if the patient is incapacitated or incompetent, by the patients authorized representative. At the most basic level this is preferably accomplished by appropriate use of access codes. These codes may be simple passwords or may make use of more complex systems. A multitude of systems for this purpose are available on the market. To prevent unauthorized access (hacking) of the data via the Internet a series of “firewalls” are preferably employed. Thus persons with malicious intent (hackers) may be prevented from accessing the DRAMR.

As indicated above, the DRAMR is preferably accessible via internet to the central medical records website. Internet access may be provided by a patient's telemedicine system, a telemedicine system's central station, a hospital/physicians computer, a home computer, etc.

The patients loved ones may be provided access the DRAMR to allow monitoring. For example, the adult child of an elderly infirm patient may be required to travel to Europe on business. In order to check on the well being of his parent he need only log on to the Web and using appropriate access codes look at the recent entries to his parent's DRAMR to ease his mind. This eliminates the need for expensive and difficult to coordinate international phone calls across many time zones. A separate area of information may be maintained for the access of family members than that available to health professionals. Optionally, family members may have access to a more limited portion of the DRAMR.

Access to health professionals is also preferably made available. For example, at an emergency room visit the emergency room physician can have rapid access to the patient record by Internet and, as such, can know accurately about the patient's condition, medications and history expediting and making more appropriate any medical decisions made. If the patient is taken ill while traveling similar access can be made. A large number of the elderly travel to warmer climates in the winter and they can more easily access and keep current their DRAMR via web access.

As previously mentioned, a number of computerized medical record keeping systems exist. In order that information may be transferred back and forth between these entities the central medical records website preferably includes a translator protocol to convert data entries into compatible formats for use at each end of the transaction.

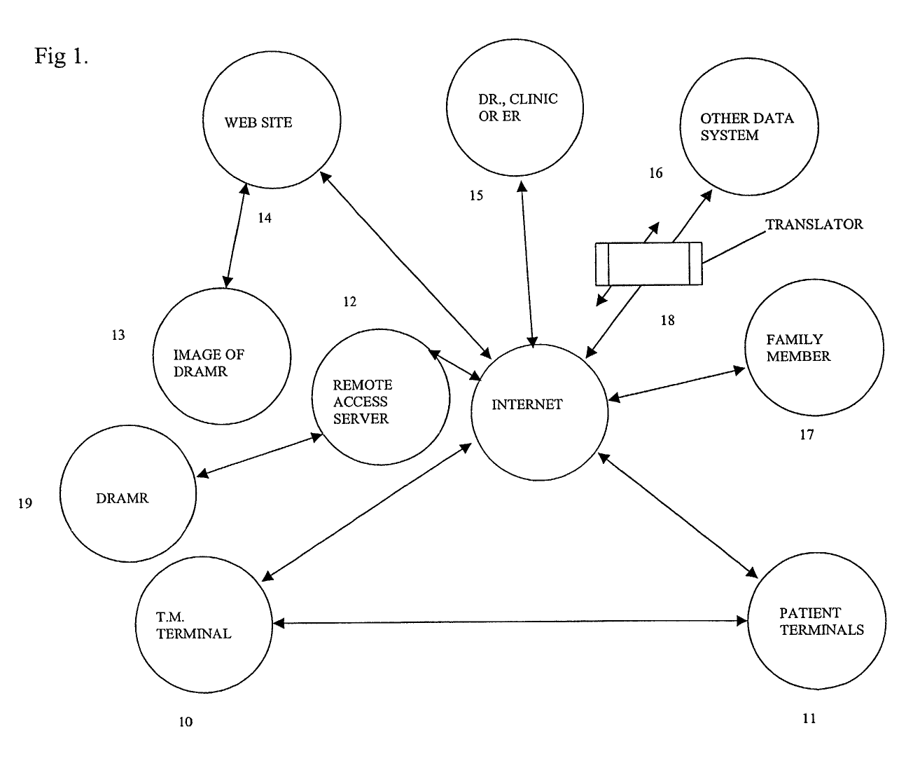

FIG. 1 shows an example of a preferred data flow stream for access to a patient's DRAMR. Primary interactions generally occur between the health professional at the central telemedicine terminal 10 and the patient at the home located terminal 11 (data from the patient's terminal may be transferred to telemedicine terminal 10 for upload to the DRAMR 19 or may be uploaded directly from terminal 11 through the internet and remote access server 12). The uploaded data is then encrypted and verified. The verified and approved data is sent to an “image of DRAMR” database 13, which is part of the central medical records website, and encrypted. The image database 13 may then be accessed by authorized healthcare providers, patients, family members, etc. via the internet and connection to the central medical records website 14. Firewall protection of the DRAMR and image of the DRAMR is provided. Doctors, clinics, emergency room personnel 15 and other hospital data systems 16 may be provided higher levels of access to DRAMR information than family members 17. Other patient data systems 16 may access DRAMR 19 and/or image of DRAMR 13 and use a translator 18 to convert data formats for compatibility at each end of the transaction.

Thus the dynamic remotely accessible medical record provides a secure and confidential but readily accessible medical record. The record is, in general, continuously updated and current through use of an internet connection to the central medical records website. The record provides rapid access for healthcare professionals to current patient information that enhances patient care in emergency situations, no matter where the patient may be. It also allows family members to monitor the well being of their loved ones from distant locations.

Note that while the above invention has been described with reference to the internet, other types of network systems, e.g. intranet, extranet, or equivalent, may be used without departing from the spirit or scope of the invention.

The present invention may be embodied in other specific forms without departing from the spirit of the essential attributes thereof, therefore, the illustrated embodiments should be considered in all respects as illustrative and not restrictive, reference being made to the appended claims rather than to the foregoing description to indicate the scope of the invention.

What is claimed:

1. A dynamic remotely accessible medical record system comprising:
a multi-level access medical information database containing medical information networked with one or more remote terminals, and optionally with one or more input devices, wherein the multi-level access medical information database is updateable by one or more users on a substantially continuous basis.

2. The dynamic remotely accessible medical record system of claim 1, further comprising a home telemedicine terminal networked with the multi-level access medical information database.

3. The dynamic remotely accessible medical record system of claim 1, wherein the one or more users includes patients, physicians, nurses and medical staff.

4. The dynamic remotely accessible medical record system of claim 1, wherein the multilevel access medical information database includes a user authorization protocol.

5. The dynamic remotely accessible medical record system of claim 4, wherein the user authorization protocol includes one or more basic levels of access and one or more higher levels of access.

6. The dynamic remotely accessible medical record system of claim 5, wherein the basic level of access provides a user with only information receiving access.

7. The dynamic remotely accessible medical record system of claim 5, wherein higher levels of access are permitted to both receive the medical information and input updated medical information.

8. The dynamic remotely accessible medical record system of claim 4, wherein the user authorization database comprises two or more datafields for receiving access information.

9. The dynamic remotely accessible medical record system of claim 1, wherein the multilevel access medical information database is networked by an intranet system, an extranet system, or combination thereof.

10. The dynamic remotely accessible medical record system of claim 1, wherein the one or more input devices are selected from the group consisting of medical devices, audio devices, video devices, and touch-key devices.

11. The dynamic remotely accessible medical record system of claim 10, wherein the medical devices include telephonic stethoscopes, EKG devices, rhythm strips, pulse oxymeters, weight sensing devices, scale devices, thermometers, spirometers, peak flow meters, blood glucose meters, prothrombine time devices, blood testing devices, and compliance devices.

12. The dynamic remotely accessible medical record system of claim 1, wherein the remote terminal comprises a data entry device and a data display device.

13. The dynamic remotely accessible medical record system of claim 12, wherein the data entry device is a keyboard or an audio capture system.

14. The dynamic remotely accessible medical record system of claim 12, wherein the data display device is a monitor or a printer or an audio broadcast device

15. The dynamic remotely accessible medical record system of claim 1, wherein the multi-level access medical information database further includes a patient diary database.

16. The dynamic remotely accessible medical record system of claim 1, wherein the multi-level access medical information database further includes a translation protocol system.

17. A dynamic remotely accessible medical record system comprising:
a multi-level access medical information databasing means for maintaining medical information, one or more means for remote information display, and optionally one or more means for information input, wherein the multi-level access medical information database means is updateable by one or more users on a substantially continuous basis.

18. The dynamic remotely accessible medical record system of claim 17, further comprising a home telemedicine terminal networked with the multi-level access medical information database means.

19. The dynamic remotely accessible medical record system of claim 17, wherein the one or more users includes patients, physicians, nurses and medical staff.

20. The dynamic remotely accessible medical record system of claim 17, wherein the multilevel access medical information database means includes a means for user authorization.

21. The dynamic remotely accessible medical record system of claim 20, wherein the means for user authorization comprises two or more datafields for receiving access information.

22. The dynamic remotely accessible medical record system of claim 20, wherein the means for user authorization provides one or more basic levels of access and one or more higher levels of access.

23. The dynamic remotely accessible medical record system of claim 22, wherein the basic level of access only permits a user to view the medical information.

24. The dynamic remotely accessible medical record system of claim 22, wherein higher levels of access are permitted to both view the medical information and update the medical information.

25. The dynamic remotely accessible medical record system of claim 17, wherein the multi-level access medical information databasing means, the one or more means for remote information display, and optionally the one or more means for information input are operably networked by an intranet system, extranet system, or combination thereof.

26. The dynamic remotely accessible medical record system of claim 17, wherein the one or more input means is selected from the group consisting of medical devices, audio devices, video devices, and touch-key devices.

27. The dynamic remotely accessible medical record system of claim 26, wherein the medical devices include telephonic stethoscopes, EKG devices, rhythm strips, pulse oxymeters, weight sensing devices, scale devices, thermometers, spirometers, peak flow meters, blood glucose meters, prothrombine time devices, blood testing devices, and compliance devices.

28. The dynamic remotely accessible medical record system of claim 17, wherein the remote information display means is a monitor or a printer or an audio broadcast device

29. The dynamic remotely accessible medical record system of claim 17, wherein the multi-level access medical information database further includes a means for providing a patient diary.

30. The dynamic remotely accessible medical record system of claim 17, wherein the multi-level access medical information database means further includes a means for translating medical information into a format that is compatible with the multi-level access medical information database means.

31. A method of dynamically remotely accessing a medical record system, comprising:
providing a multi-level access medical information database containing medical information networked with one or more remote terminals, and optionally with one or more input devices, wherein the multi-level access medical information database is updateable by one or more users on a substantially continuous basis,
providing a user authorization protocol for restricting access to approved users, logging into the multi-level access medical information database, receiving medical information from the remote terminal, and optionally inputting medical information from the input device.

32. The method of dynamically remotely accessing a medical record system of claim 29, wherein the multi-level access medical information database is further networked with a home telemedicine terminal.

33. The dynamic remotely accessible medical record system of claim 1, wherein the one or more users includes patients, physicians, nurses and medical staff.
